(19) United States
(12) Patent Application Publication
(10) Pub. No.: US 2024/0361777 A1
(43) Pub. Date: Oct. 31, 2024

(54) GYRO UNIT AND STEERING SYSTEM

(71) Applicant: Futaba Corporation, Chiba-ken (JP)

(72) Inventors: Masahiro TANAKA, Chiba-ken (JP); Yuhei SUZUKI, Chiba-ken (JP)

(21) Appl. No.: 18/643,213

(22) Filed: Apr. 23, 2024

(30) Foreign Application Priority Data
Apr. 26, 2023 (JP) 2023-72457

(51) Int. Cl. G05D 1/245; B64C 19/00; G05D 1/223; G05D 109/22; G05D 111/50

(52) U.S. Cl. CPC G05D 1/245; B64C 19/00; G05D 1/223; B64C 2203/00; G05D 2109/22; G05D 2111/52

(57) ABSTRACT

A gyro unit mounted on a steered object for performing steering based on a steering signal received from the outside comprises a gyro sensor, a calculation portion and a controller. The calculation portion is configured to perform calculations for posture control of the steered object based on the steering signal and a detection signal of the gyro sensor. The controller is configured to perform control such that a control direction of the posture control switches when the steered object moves forward and backward.

### CROSS-REFERENCE TO RELATED APPLICATIONS

This application claims priority to Japanese Patent Application No. 2023-072457 filed on Apr. 26, 2023, the entire contents of which are incorporated herein by reference.

### TECHNICAL FIELD

The present disclosure pertains to a technical field of a gyro unit mounted on a steered object that performs steering based on a steering signal received from the outside, and a steering system including a transmitter that transmits the steering signal to the steered object and the gyro unit.

### BACKGROUND

Steering systems for remotely steering steered objects such as model airplanes, drones, and model vehicles have a posture control function using a gyro sensor, as disclosed in Japanese Laid-open Patent Publication No. 2022-43623 and Japanese Laid-open Patent Publication No. 2022-65402, for example.

Specifically, Japanese Laid-open Patent Publication No. 2022-43623 and Japanese Laid-open Patent Publication No. 2022-65402 disclose examples in which a posture control function using a gyro sensor is applied to a steering system for a model airplane.

Here, regarding model airplanes, it is becoming popular among enthusiasts to perform a so-called 4D flight, which is capable of not only forward movement but also backward movement. The 4D flight refers to acrobatic flight performances that utilize the reverse function, such as a handstand torque roll, sudden turns when going backwards, and repeated forward and backward movements.

The 4D flight tends to use relatively small model airplanes with wingspans of around 1 meter, for example.

In the 4D flight, flights are carried out either without a gyro sensor and using only steering techniques, or with a gyro sensor and utilizing posture control only when going backwards.

### SUMMARY

Herein, when posture control is performed using a gyro sensor, the control direction of posture control needs to be uniquely determined for each axis for which angular velocity is detected, such as roll, pitch, and yaw. Currently, the posture control may only be appropriately performed in either forward or backward movement.

Accordingly, when the gyro sensor is mounted in a direction suitable for backward movement with priority given to ease of steering during backward movement, the performance during forward movement needs be performed using only steering techniques, which increases the difficulty of steering. Similarly, in the opposite case, the difficulty of steering when going backwards increases.

The present disclosure has been made in view of the above circumstances, and aims to improve the ease of steering when performing steering that involves the backward movement of a steered object by making it possible to use a posture control function both during forward movement and backward movement.

A gyro unit according to an embodiment of the present disclosure is mounted on a steered object for performing steering based on a steering signal received from the outside, and includes: a gyro sensor; a calculation portion configured to perform calculations for posture control of the steered object based on the steering signal and a detection signal of the gyro sensor; and a controller configured to perform control such that a control direction of the posture control switches when the steered object moves forward and backward.

Further, the steering system according to an embodiment of the present disclosure is configured to include a transmitter configured to transmit a steering signal to a steered object to be steered based on the steering signal, and a gyro unit mounted on the steered object, wherein the transmitter includes a transmission portion configured to transmit a signal, and the gyro unit includes: a gyro sensor; a calculation portion configured to perform calculations for posture control of the steered object based on a detection signal of the gyro sensor; and a gyro-side controller configured to perform control such that a control direction of the posture control switches when the steered object moves forward and backward.

By using the gyro unit with the above configuration, the posture control function may be used both during forward movement and backward movement.

According to an embodiment of the present disclosure, it is possible to improve the ease of steering when performing a steering that involves moving the steered object backwards.

### BRIEF DESCRIPTION OF THE DRAWINGS

FIG. 1 is a diagram illustrating an example of a configuration of a steering system as an embodiment of the present disclosure.

FIG. 2 is a diagram illustrating an example of the internal configuration of a transmitter and a steered object in an embodiment.

FIG. 3 is an explanatory diagram illustrating an example of a configuration of a gyro unit in an embodiment.

FIG. 4 is a diagram illustrating an example of a setting screen for setting channel allocation.

FIG. 5 is a diagram illustrating an example of a setting screen for program mixing of a transmitter.

FIG. 6 is a diagram illustrating an example of a screen related to ACT/INH settings and ON/OFF switch settings in program mixing.

FIG. 7 is a diagram illustrating an example of a setting screen related to ON/OFF of program mixing.

FIG. 8 is a diagram illustrating an example of a screen displayed in response to connection of a gyro unit.

FIG. 9 is a diagram illustrating an example of a channel allocation setting screen on a gyro unit side.

FIG. 10 is a diagram illustrating an example of a setting screen for modes of D2 to D5 on the gyro unit side.

FIGS. 11A to 11E are diagrams illustrating an example of a setting screen for setting a combination of control directions for each gyro sensor during backward movement.

FIG. 12 is a flowchart showing an example of a processing procedure on a transmitter side in a first embodiment.

FIG. 13 is a flowchart showing an example of a processing procedure on the gyro unit side in the first embodiment.

FIG. 14 is a diagram illustrating an example of a setting screen for setting channel allocation in a transmitter.

FIG. 15 is a diagram illustrating an example of a channel allocation setting screen on the gyro unit side.

FIG. 16 is a diagram illustrating an example of a mode setting screen in another example of the first embodiment.

FIGS. 17A and 17B are diagrams illustrating an example of a setting screen for setting a combination of control directions for each gyro sensor in another example of the first embodiment.

FIG. 18 is an explanatory diagram of a configuration example of a gyro unit as a second embodiment.

FIG. 19 is a flowchart of processing performed by a gyro controller in the second embodiment.

FIG. 20 is an explanatory diagram of a configuration example of a gyro unit as another example of the second embodiment.

FIG. 21 is a flowchart showing an example of a processing procedure when a dead zone is implemented by processing on the gyro unit side.

### DETAILED DESCRIPTION

Hereinafter, embodiments of the present disclosure will be described in the following order.
<1. First embodiment>
[1-1. Example of system configuration]
[1-2. Example of configurations of transmitter and steered object]
[1-3. Example of configuration of gyro unit]
[1-4. Regarding the control direction switching method and presetting as an embodiment]
[1-5. Example of processing procedure]
[1-6. Another example of the first embodiment]

### 2. Second Embodiment

<3. Modified example>
<4. Summary of embodiments>

### 1. First Embodiment

### 1-1. Example of System Configuration

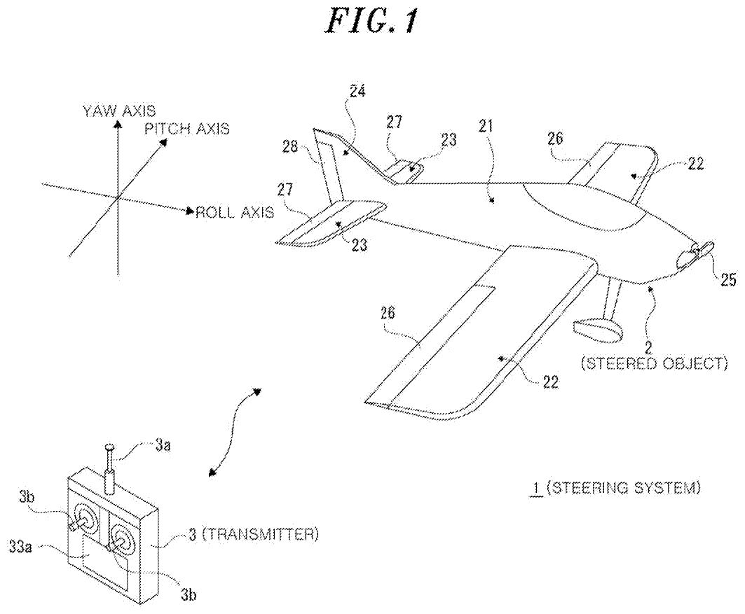

FIG. 1 is a diagram illustrating an example of the configuration of a steering system 1, which is an embodiment of the steering system according to an embodiment of the present disclosure.

As illustrated, the steering system includes at least a steered object 2 and a transmitter 3.

The steered object 2 is an object that is steered based on a steering signal received from the outside. Further, the transmitter 3 is a device that transmits various signals including the steering signal to the steered object 2.

In this embodiment, a model airplane is used as an example of the steered object 2.

As illustrated in the drawings, the steered object 2 as a model airplane includes a fuselage portion 21, a pair of left and right main wings 22 and 22 and horizontal rear wings 23, 23, and a vertical rear wing 24, respectively.

Herein, the posture of the steered object 2 may be expressed by the rotation direction around a roll axis, the rotation direction around a pitch axis, and the rotation direction around a yaw axis. In the drawings, each direction of the roll axis, pitch axis, and yaw axis is illustrated, but as illustrated in the drawings, the roll axis passes through the fuselage portion 21 of the steered object 2 back and forth, the pitch axis passes through the steered object 2 from left and right, and the yaw axis passes through the steered object 2 up and down.

In the steered object 2, each main wing 22 is provided with an aileron 26. Further, each horizontal rear wing 23 is provided with an elevator 27, and each vertical rear wing 24 is provided with a rudder 28.

The aileron 26 is a movable wing portion for rotating the steered object 2 around the roll axis. Further, the elevator 27 is a movable wing portion for rotating the steered object 2 around the pitch axis, and the rudder 28 is a movable wing portion for rotating the steered object 2 around the yaw axis.

By operating the aileron 26, elevator 27, and rudder 28, the flight posture of the steered object 2 may be changed.

Further, the steered object 2 is provided with a propeller 25. The rotation of the propeller 25 may provide a forward and backward propulsion force to the steered object 2.

The steered object 2 of this embodiment is configured to be able to switch the rotation direction of the propeller 25. By switching the rotation direction of the propeller 25, it is possible to switch the steered object 2 between forward and backward movements.

The transmitter 3 has a function of receiving manipulations for steering by a user as a pilot, and transmitting a steering signal in accordance with the received manipulations.

The transmitter 3 is provided with an antenna 3a for wirelessly transmitting a steering signal, a manipulator 3b for receiving manipulation input for steering, and a display screen 33a for displaying various pieces of information to a user such as a pilot.

Herein, the example shows a type of the transmitter 3 with two stick-shaped manipulators as the manipulator 3b for steering. However, the form of the manipulator 3b is not limited to the stick-shape, but other forms such as a wheel shape are also contemplated. Further, the number of manipulators 3b is also contemplated to be other than two.

Herein, in this specification, the term “steering signal” refers to a signal that instructs the operation of movable portions of the steered object 2, such as the propeller 25, the aileron 26, the elevator 27, and the rudder 28.

In the steering system 1, signals other than the steering signal instructing the operation of the movable portion may also be transmitted from the transmitter 3 to a steered object 2 side.

In the steering system 1 of this embodiment, a plurality of channels may be used as signal transmission channels from the transmitter 3 to the steered object 2 side according to the standard. Specifically, in the steering system 1 in this example, a total of 18 channels (CH1 to CH16, and DG1 and DG2) are prepared as signal transmission channels.

Using these multiple channels, it is possible to transmit steering signals for each movable portion such as the propeller 25, the aileron 26, the elevator 27, and the rudder 28, separately for each channel. Specifically, it is possible to set which signal to transmit for each channel, such as allocating a steering signal of the propeller 25 to CH1, a steering signal of the aileron 26 to CH2, and a steering signal of the elevator 27 to CH3.

In such allocation settings of transmission signals for each channel, it is also possible to allocate signals other than steering signals as transmission signals.

### 1-2. Example of Configurations of Transmitter and Steered Object

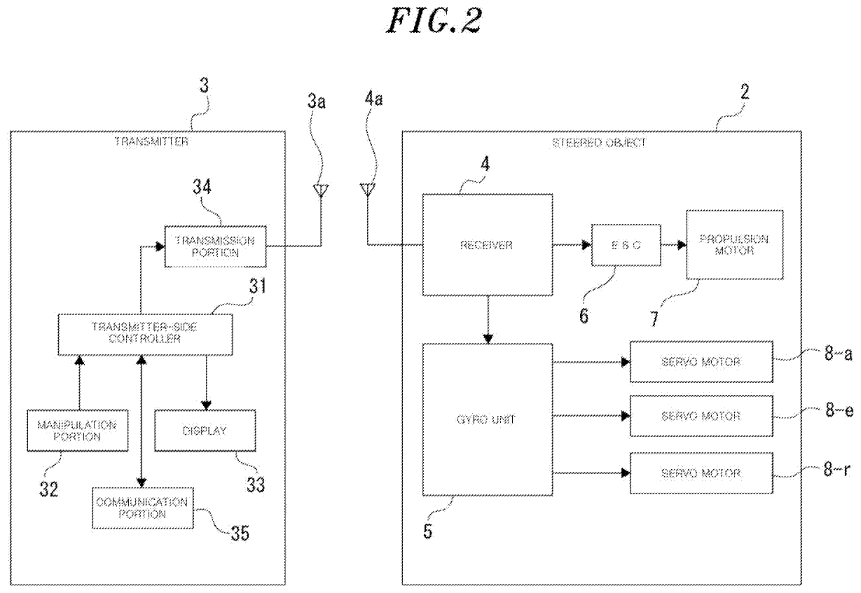

An example of the internal configuration of the transmitter 3 and the steered object 2 will be described with reference to the block diagram in FIG. 2.

In FIG. 2, an example of the electrical configuration of the transmitter 3 and the steered object 2 is shown, and illustration of the mechanical configuration is omitted.

As illustrated, the transmitter 3 includes a transmitter-side controller 31, a manipulation portion 32, a display 33, a transmission portion 34, and a communication portion 35.

The manipulation portion 32 comprehensively represents the operators used by a user to input various manipulations to the transmitter 3. Specifically, the manipulation portion 32 comprehensively represents the aforementioned stick-shaped manipulator 3b for steering manipulations, and manipulators such as buttons, keys, levers, touch panels, etc. for performing various manipulations other than steering manipulations.

In the transmitter 3 of this example, a touch panel for detecting touch manipulations on a screen is formed on the aforementioned display screen 33a, and the touch panel is included in the manipulators in the manipulation portion 32.

The display 33 includes a display device such as an LCD (Liquid Crystal Display) or an organic EL (Electro Luminescence) display, and displays various pieces of information to a user.

The aforementioned display screen 33a is a display screen on the display 33.

The transmitter-side controller 31 is configured with a microcomputer provided with, for example, a CPU (Central Processing Unit), a ROM (Read Only Memory), a RAM (Random Access Memory), etc., and performs overall control of the transmitter 3 by having the CPU execute processing according to a program stored in a memory such as a ROM.

For example, the transmitter-side controller 31 performs a processing of generating a steering signal based on the manipulation of the aforementioned manipulator 3b on the manipulation portion 32.

Further, the transmitter-side controller 31 performs a processing of displaying various pieces of information on the display 33 based on a manipulation on a predetermined manipulator other than the manipulator 3b in the manipulation portion 32, particularly the touch panel on the display screen 33a described above in this example. For example, the transmitter-side controller 31 performs a processing of causing the display 33 to display a setting menu screen, display a setting screen for an item selected from the setting menu screen, and the like. In addition, on the setting screen, a processing is performed to display information such as a value instructed by a user through a manipulation on the manipulation portion 32, and a setting processing corresponding to the manipulation is performed based on the instruction manipulation in the settings.

Further, the transmitter-side controller 31 performs a processing of causing the transmission portion 34 to transmit signals to be transmitted to the steered object 2 side, such as the generated steering signal.

The transmission portion 34 transmits a signal instructed by the transmitter-side controller 31 via the antenna 3a.

Additionally, the transmission portion 34 may have a receiving function as well as a transmitting function. When a receiver 4, which will be described later, has a transmitting function, the transmitter 3 may receive information acquired on the steered object 2 side. For example, when the steered object 2 is provided with a monitoring sensor such as a temperature sensor or a rotation speed sensor for the propeller 25 (a propulsion motor 7 to be described later), the information detected by the sensor may be received by the transmitter 3 and displayed on the display 33.

The communication portion 35 is a communication device for performing wired communication with external equipment.

The transmitter-side controller 31 is enabled to communicate with an external device connected to the transmitter 3 by wire, particularly with a gyro unit 5 described later in this embodiment, via the communication portion 35.

The steered object 2 includes the receiver 4, the gyro unit 5, an ESC (Electronic Speed Controller; also called a speed controller) 6, the propulsion motor 7, and a plurality of servo motors 8.

The propulsion motor 7 is a motor that rotationally drives the propeller 25 shown in FIG. 1n this embodiment, as the propulsion motor 7, a motor whose rotation direction may be switched depending on the polarity of a drive current is used.

Three servo motors 8 are provided: a servo motor 8-a that drives the aileron 26, a servo motor 8-e that drives the elevator 27, and a servo motor 8-r that drives the rudder 28.

The receiver 4 has an antenna 4a and receives the signal transmitted by the transmission portion 34 in the transmitter 3.

The receiver 4 outputs the received signal to the ESC 6 and the gyro unit 5.

The ESC 6 acquires a steering signal that instructs the operation of the propeller 25, which is included in the transmission signal from the transmitter 3 that is input via the receiver 4, and generates a drive signal for the propulsion motor 7 based on the steering signal.

This drive signal is output to the propulsion motor 7, and the propulsion motor 7 is driven.

The gyro unit 5 has gyro sensors 52 corresponding to each axis of a roll axis, a pitch axis, and a yaw axis, as will be described later, and controls the posture of the steered object 2 based on the detection signals (angular velocity detection signal) of these gyro sensors.

Although the details will be described later, the gyro unit 5 extracts a steering signal that instructs the operation of the aileron 26 (hereinafter referred to as “aileron steering signal”), a steering signal that instructs the operation of the elevator 27 (hereinafter referred to as “elevator steering signal”), and a steering signal that instructs the operation of the rudder 28 (hereinafter referred to as “rudder steering signal”), which are included in the transmission signal from the transmitter 3 input through the receiver 4, and generates a drive signal for implementing posture control (posture stabilization control) as a drive signal for each of the servo motors 8-a, 8-e, and 8-r based on the steering signal and the detection signal of each gyro sensor.

By driving the servo motors 8-a, 8-e, and 8-r based on the drive signals generated by the gyro unit 5 as such, posture stabilization control of the steered object 2 is implemented.

### 1-3. Example of Configuration of Gyro Unit

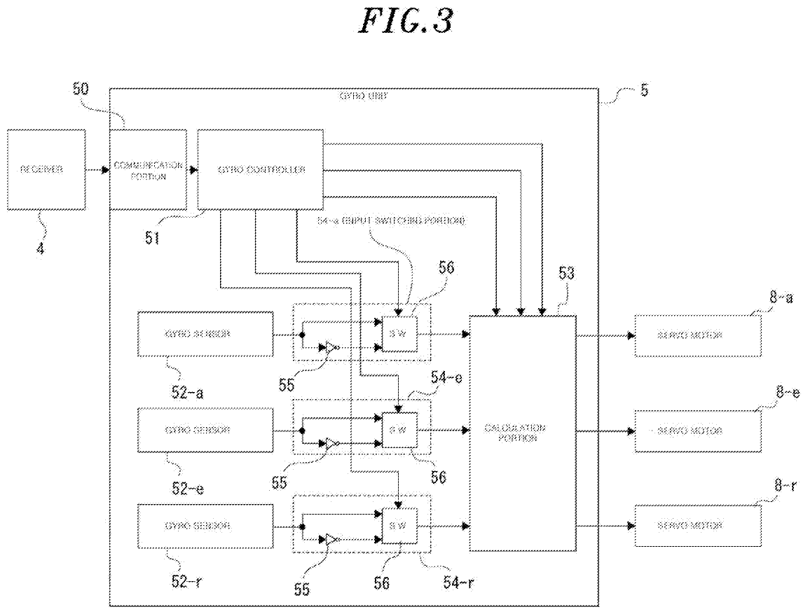

FIG. 3 is an explanatory diagram of an example of a configuration of the gyro unit 5.

Additionally, in FIG. 3, the receiver 4 and the servo motors 8-a, 8-e, and 8-r shown in FIG. 2 are shown together with an example of the configuration of the gyro unit 5.

As illustrated, the gyro unit 5 includes a communication portion 50, a gyro controller 51, a gyro sensor 52 (52-a, 52-e, and 52-r) for each axis, a calculation portion 53, and an input switching portion 54 (54-a, 54-e, and 54-r) for each axis.

The gyro sensor 52-a detects the angular velocity around the roll axis (rotation direction by the aileron 26). Furthermore, the gyro sensor 52-e detects the angular velocity around the pitch axis (rotation direction by the elevator 27), and the gyro sensor 52-r detects the angular velocity around the yaw axis (rotation direction by the rudder 28).

By installing the gyro unit 5 in the correct direction on the steered object 2, these gyro sensors 52-a, 52-e, and 52-r may each detect the angular velocity around the desired axis.

The gyro controller 51 is capable of wired communication with an external device via the communication portion 50. When the steered object 2 is steered, the receiver 4 is connected by wire to the communication portion 50 as illustrated in the drawings, and the gyro controller 51 is capable of receiving a transmission signal from the transmitter 3 that is received by the receiver 4 via the communication portion 50.

The gyro controller 51 extracts an aileron steering signal, an elevator steering signal, and a rudder steering signal included in the transmission signal from the transmitter 3 input via the receiver 4, and outputs these steering signals to the calculation portion 53.

As mentioned above, in this example, which steering signal is to be transmitted on which channel is set in advance, so the gyro controller 51 extracts an aileron steering signal, an elevator steering signal, and a rudder steering signal from the transmission signal according to the settings.

Herein, the gyro controller 51 in this embodiment also performs various processes according to switching between forward and backward movements of the steered object 2, but this will be described again later.

The aileron steering signal, elevator steering signal, and rudder steering signal are input to the calculation portion 53 via the gyro controller 51, and the detection signals of the gyro sensors 52-a, 52-e, and 52-r are input via the input switching portions 54-a, 54-e, and 54-r, respectively.

In addition, the input switching portions 54-a, 54-e, and 54-r will be described again later.

The calculation portion 53 performs, based on a detection signal of the gyro sensor 52-a input via the input switching portion 54-a (hereinafter referred to as “roll axis angular velocity signal”), a detection signal of the gyro sensor 52-e input via the input switching portion 54-e (hereinafter referred to as “pitch axis angular velocity signal”), and a detection signal of the gyro sensor 52-r input via the input switching portion 54-r (hereinafter referred to as “yaw axis angular velocity signal”), and an aileron steering signal, an elevator steering signal, and a rudder steering signal input from the gyro controller 51, calculations for posture stabilization control for each of the roll, pitch, and yaw axes, and generates drive signals for each of the servo motors 8-a, 8-e, and 8-r.

The calculation portion 53 in this example performs a PID (Proportional Integral Differential) control calculation based on a steering signal and an angular velocity detection signal for each of the roll, pitch, and yaw axes, thereby generating drive signals for each of the servo motors 8-a, 8-e, and 8-r for implementing posture stabilization control.

Specifically, regarding the roll axis, a target rotation angle of the steered object 2 around the roll axis is calculated based on the aileron steering signal, and a PID control calculation is performed based on this target rotation angle and the roll axis angular velocity signal, thereby generating a drive signal for the servo motor 8-a that drives the aileron 26.

In addition, regarding the pitch axis, the target rotation angle of the steered object 2 around the pitch axis is calculated based on the elevator steering signal, and a PID control calculation is performed based on this target rotation angle and the pitch axis angular velocity signal, thereby generating a drive signal for the servo motor 8-e that drives the elevator 27.

In addition, regarding the yaw axis, the target rotation angle of the steered object 2 around the yaw axis is calculated based on the rudder steering signal, and a PID control calculation is performed based on this target rotation angle and the yaw axis angular velocity signal, thereby generating a drive signal for the servo motor 8-4 that drives the rudder 28.

In addition, the posture control calculation based on the detection signal of the gyro sensor is not limited to the PID control calculation, and other feedback control calculations may also be adopted.

Furthermore, the posture control based on the detection signal of the gyro sensor is not limited to feedback control, and may be feedforward control.

### 1-4. Regarding the Control Direction Switching Method and Presetting as an Embodiment

Herein, the steered object 2 in this embodiment is configured to be able to switch between forward and backward movements, but as described above, in the conventional technology, posture control using the gyro sensor 52 may only be performed in either forward or backward movement.

Accordingly, in this embodiment, in order to enable the posture control function using the gyro sensor 52 both in forward and backward movements, a method is adopted in which the control direction of posture control switches when the steered object 2 moves forward and backward.

In this example, switching of the control direction is implemented using the input switching portion 54 (54-a, 54-e, and 54-r) shown in FIG. 3.

As shown in FIG. 3, each input switching portion 54 includes an inverting circuit 55 and a switch (SW) 56. In each input switching portion 54, a detection signal of the gyro sensor 52 of the corresponding axis among the gyro sensors 52-a, 52-e, and 52-r and a signal obtained by inverting the detection signal of the gyro sensor 52 of the corresponding axis by the inverting circuit 55 are input to the switch 56. In other words, a non-inverted signal and an inverted signal of the detection signal of the gyro sensor 52 of the corresponding axis are input to the switch 56. The switch 56 in each input switching portion 54 outputs either the non-inverted signal or the inverted signal input as such to the calculation portion 53 based on a switching instruction from the gyro controller 51.

This makes it possible to switch the control direction (which may also be called a direction in which the correction rudder is applied) for posture control of each axis using the gyro sensors 52-a, 52-e, and 52-r.

Herein, it may be contemplated that switching the control direction of the posture control may be performed within the calculation in the calculation portion 53, such as by switching the polarity of the target rotation angle in the PID control described above. However, in that case, it has been identified that there is a risk that the stability of posture control may decrease due to calculation errors.

By using a method of switching the polarity of the angular velocity signal input to the calculation portion 53 as described above, even when PID control is applied to posture control, an appropriate posture control signal may be obtained according to the switching between forward and backward movements. Accordingly, it is possible to improve the precision of posture control during forward and backward movements.

In this embodiment, as described above, forward/backward movement of the steered object 2 is switched by switching the rotation direction of the propulsion motor 7. In addition, in this example, switching of the rotation direction of the propulsion motor 7 is implemented by a manipulation input from the manipulator 3b for instructing the propeller 25 to operate. Specifically, when the manipulator 3b is manipulated from the neutral position (“0” position) in a positive direction (for example, in an upward direction), the propulsion motor 7 rotates forward and the steered object 2 moves forward. When the manipulator 3b is manipulated from the neutral position in a negative direction (for example, in a downward direction), the propulsion motor 7 rotates reverse and the steered object 2 moves backward.

Hereinafter, the manipulator 3b for instructing the operation of the propeller 25 will be referred to as a “throttle manipulator,” the operation using the throttle manipulator will be referred to as a “throttle manipulator,” and the amount of manipulation of the throttle manipulator will be referred to as a “throttle manipulation amount.” Further, the manipulation position of the throttle manipulator based on the aforementioned neutral position will be referred to as a “throttle manipulation position.” The throttle manipulation position may change between a plus side and a minus side with respect to the neutral position, and accordingly, the throttle manipulation position may be considered to have positive/negative polarity.

Furthermore, in the following description, a steering signal for instructing the operation of the propeller 25, which is determined according to the manipulation of the throttle manipulator, will be referred to as a “throttle signal.”

In this example, it is assumed that the throttle signal is a signal that instructs forward/reverse rotation of the propulsion motor 7 depending on its polarity. Specifically, it is assumed that a throttle signal of positive polarity indicates the number of rotations of the propulsion motor 7 on a forward rotation side, and a throttle signal of negative polarity indicates the number of rotations of the propulsion motor 7 on the reverse rotation side.

In this example, the forward/reverse movement of the steered object 2 is switched in accordance with the inversion of the polarity of the throttle manipulation position, and thus switching control of the control direction of posture control is performed based on the throttle manipulation position.

It may be contemplated that when the control direction of the posture control is switched in accordance with switching between forward and backward movements of the steered object 2, the gyro controller 51 is made to refer to a throttle signal and determines switching between forward and backward movements of the steered object 2 based on the throttle signal, and switching control of the switch 56 is performed. However, in this example, the gyro controller 51 is not made to refer to the throttle signal, but instead, a method is adopted in which a switching notification signal separate from the throttle signal is generated in the transmitter 3 and the gyro controller 51 is made to refer to the switching notification signal.

The switching notification signal referred to herein is a signal related to forward/reverse switching manipulation. In this example, the transmitter-side controller 31 in the transmitter 3 generates a switching notification signal based on the throttle manipulation position, and transmits the same to the steered object 2 side via the transmission portion 34.

In this example, a specific channel among a plurality of signal transmission channels is allocated to transmit the switching notification signal.

Specifically, in this example, a program mixing function of the transmitter 3 is used to transmit the switching notification signal based on the throttle manipulation position.

The program mixing function is a function that, in conjunction with a certain manipulation, transmits an operation instruction signal in a pre-specified manner for that manipulation through a pre-specified signal transmission channel.

With this program mixing function, a switching notification signal is transmitted to the gyro controller 51 in conjunction with the throttle manipulation, instructing execution of switching control of the control direction in accordance with forward/reverse switching.

Furthermore, in this example, the control direction during reverse movement may be individually set for each of the gyro sensors 52.

For example, depending on the type of performance using the steered object 2, such as flight performance using the steered object 2 as a flying object, and the preference of a pilot, it may be contemplated that regarding the control direction during backward movement, it may be requested that the control direction of all gyros (detection target axes) be reversed from the forward direction, or that the control direction of some gyros be the same as the forward direction.

By making it possible to individually set the control direction during backward movement for each gyro sensor 52 as described above, it becomes possible to meet such various needs and improve usability.

Furthermore, in this example, a combination of settings of control directions for each gyro sensor 52 during backward movement as described above may be selected from among a plurality of preset combinations.

Specifically, in this example, the control direction for each gyro sensor 52 during backward movement may be set in advance for each of the modes of D2 to D5, which will be described later, provided by the program mixing function. In other words, in this connection, it is possible to preset four types of combinations as a combination of control directions for each gyro sensor 52 during backward movement. In addition, after this pre-setting, a user performs a manipulation to designate any one of D2 to D5 described above on the transmitter 3, so that it becomes possible to select a combination of control directions for each gyro sensor 52 during backward movement from among the above four types of combinations.

Herein, the control direction during forward movement is allocated to the mode D1. In this example, the control direction for each gyro sensor 52 during forward movement is fixed and may not be changed by a user. Specifically, in this example, the control direction for each gyro sensor 52 during forward movement is all decided to be the forward direction (in other words, in this example, the direction in which the switch 56 selects a non-inverted signal).

With the program mixing function, when the designated channel (specific channel) is any of CH1 to CH16, the pulse width of the transmission signal of the specific channel will be changed for each mode from D1 to D5.

In the transmitter 3, when it is determined that a forward manipulation is being performed based on the throttle manipulation position, the transmitter-side controller 31 transmits a transmission signal of a specific channel, that is, a signal with a pulse width corresponding to a mode of D1 as a switching notification signal. On the other hand, when it is determined that a backward manipulation is being performed based on the throttle manipulation position, the transmitter-side controller 31 performs a processing of transmitting a signal having a pulse width corresponding to a designated mode among modes of D2 to D5 as a switching notification signal to be transmitted on a specific channel.

On a gyro unit 5 side, the gyro controller 51 refers to the switching notification signal transmitted on a specific channel. When the pulse width of the switching notification signal corresponds to a pulse width corresponding to the mode of D1, in order to set the control direction of the posture control to a forward direction, each input switching portion 54 selects a non-inverted signal using the switch 56.

Further, when the pulse width of the switching notification signal is a pulse width other than the pulse width corresponding to the mode of D1, the gyro controller 51 controls the switches 56 in each input switching portion 54 so that the control direction for each gyro sensor 52 set to the mode specified by the pulse width among modes from D2 to D5 is implemented.

In this way, switching of the control direction of posture control is implemented in accordance with the switching between forward and backward movements. In addition, during backward movement, as a combination of control directions for each gyro sensor 52, a combination designated by a user manipulation on the transmitter 3 may be selected from among preset combinations.

Furthermore, in this embodiment, instead of switching the control direction at the timing when the polarity of the throttle manipulation position is inverted, the timing for switching the control direction is delayed relative to the timing when the polarity of the throttle manipulation position is inverted.

In this example, such delay processing is performed on a transmitter 3 side. Specifically, the transmitter-side controller 31 delays the timing at which the pulse width of the switching notification signal described above is changed with respect to the polarity change timing at the throttle manipulation position.

In this example, this delay is also performed using the program mixing function.

Herein, in the program mixing function, it is possible to designate the manipulation position for switching ON/OFF of program mixing with respect to the main manipulation (throttle manipulation in this example) as an interlocked manipulation. For example, the manipulation position=0 may be designated as the manipulation position for switching ON/OFF of program mixing.

In addition, turning on program mixing corresponds to switching the pulse width of the transmission signal of a specific channel from the pulse width corresponding to D1 mentioned above to the pulse width corresponding to the selected mode from D2 to D5. Turning off program mixing corresponds to switching the pulse width of the transmission signal of a specific channel from the pulse width corresponding to the selected mode among D2 to D5 to the pulse width corresponding to D1.

In addition, in the program mixing function, it is possible to designate an arbitrary delay time from when the manipulation position for the main manipulation reaches the designated manipulation position until the program mixing is actually switched ON/OFF. In this example, the delay function of such a program mixing function is used to delay the pulse width switching timing of the switching notification signal.

Furthermore, in this embodiment, regarding the switching manipulation between forward and backward movements, the pulse width of the switching notification signal is not switched until a manipulation amount in the progress direction after switching exceeds a predetermined manipulation amount (instruction to switch the control direction is not performed).

Specifically, when the polarity of the throttle manipulation position is switched, the pulse width of the switching notification signal is not switched until a throttle manipulation amount on a polarity side after switching exceeds a predetermined manipulation amount. This may be said to provide a “dead zone” in which the control direction is not switched in an area near 0 with respect to the throttle manipulation position.

Such a dead zone may also be set using the program mixing function. Specifically, in the program mixing function, for the aforementioned main manipulations, the manipulation position to turn program mixing ON (hereinafter referred to as “ON position”) and the manipulation position to turn the program mixing OFF (hereinafter referred to as “OFF position”) may be designated. Accordingly, by designating positions other than “0” as these ON and OFF positions, the dead zone described above may be set.

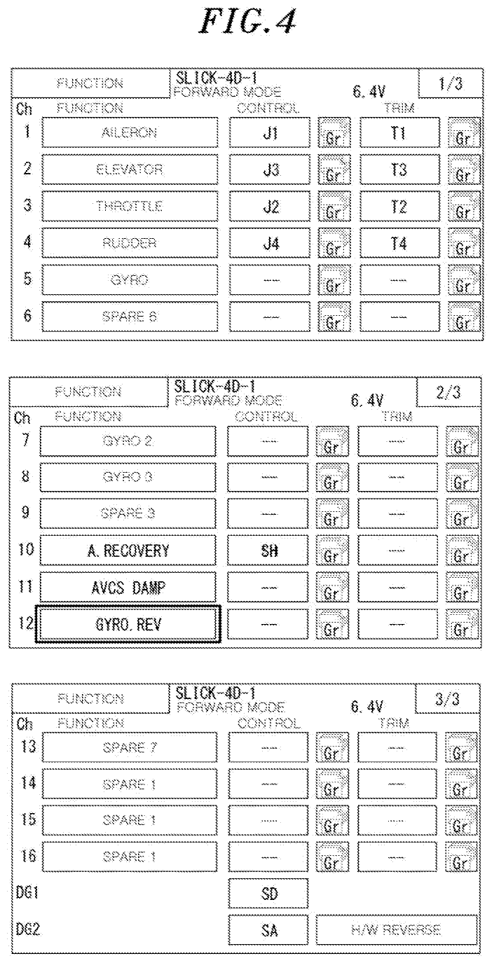

With reference to FIGS. 4 to 11, examples of presetting that a user needs to perform in order to implement the control direction switching method as the first embodiment described above will be described.

FIGS. 4 to 7 are diagrams for explaining the presetting that need to be made to the transmitter 3, and show examples of various setting screens that may be fetched from the aforementioned setting menu screen. For confirmation, these setting screens are displayed on the display screen 33a of the display 33, and in this example, the aforementioned touch panel provided on the display screen 33a allows a user to perform various manipulation inputs on the setting screen by performing a touch manipulation on the display screen 33a.

FIG. 4 shows an example of a setting screen for setting channel allocation. The setting screen has three pages, and the screens of each page are shown together in the drawings.

As illustrated in the drawings, in this example, out of a total of 18 signal transmission channels (CH1 to CH16, and DG1 and DG2), as an example, CH12 is allocated as the signal transmission channel for the aforementioned switching notification signal (see “GYRO. REV” in the drawings).

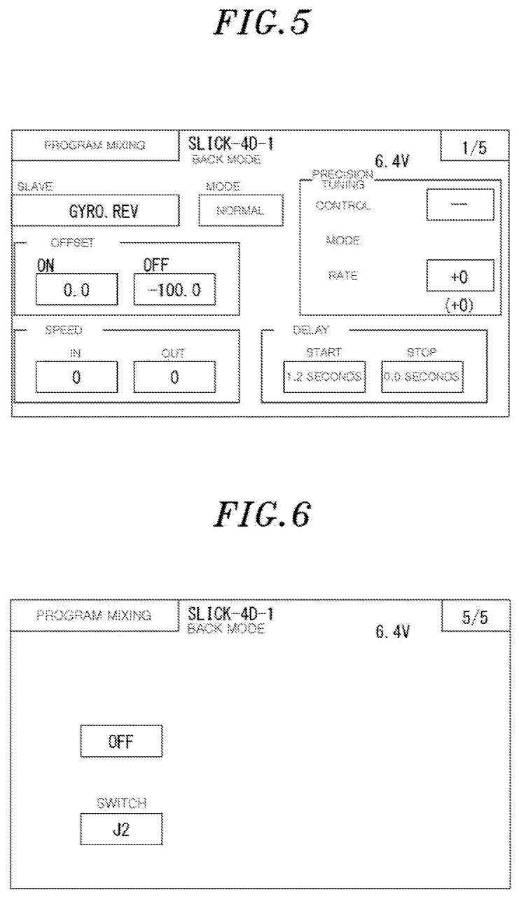

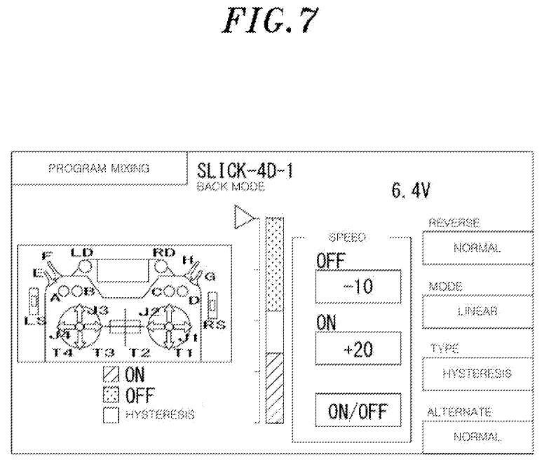

FIGS. 5 to 7 show examples of setting screens related to the program mixing function. FIG. 5 shows an example of a setting screen for program mixing of the transmitter. FIG. 6 shows an example of a screen related to ACT/INH settings and ON/OFF switch settings in the program mixing. FIG. 7 shows an example of a setting screen related to ON/OFF of the program mixing.

On the setting screen shown in FIG. 5, it is possible to make settings related to each mode and delay time of D1 to D5 mentioned above, and as shown in the drawings, a setting area is provided for setting each item of “slave,” “offset,” “speed,” and “delay”.

The setting area of “slave” is an area for setting a channel for transmitting an operation instruction signal linked to the main manipulation. As described above, in this example, “GYRO.REV” (=CH12) is designated as the signal transmission channel of the switching notification signal, and thus “GYRO. REV” is set for “slave.”

The setting area of “offset” is an area for setting an offset value related to the pulse width of the transmission signal (operation instruction signal linked to the main manipulation). Herein, in the steering system 1 of this example, the lower limit value to the upper limit value of the pulse width of the transmission signal are expressed by numerical values from “−100” to “100.” In this example, the mode of D1 (forward mode) is a mode in which the pulse width is a lower limit value. Hence, as illustrated in the drawings, the “OFF” item in “offset” is set to “−100 (−100.0),” which represents the lower limit value. For confirmation, “OFF” herein means “OFF” of program mixing.

Further, the “ON” item in “offset” is an item for selecting modes from D2 to D5.

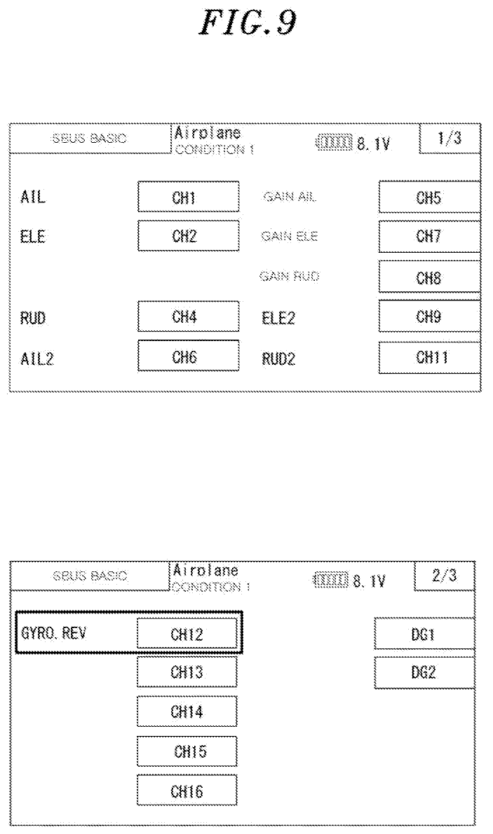

In the program mixing function, it is possible to change the pulse width of the transmission signal in five stages so that a total of five modes from D1 to D5 may be identified. In other words, in this connection, the pulse width of the transmission signal may be changed, according to the range notation from “−100” to “100” above, among a pulse width corresponding to the range from “−100” to “−75” (representative value=“−100.0”), a pulse width corresponding to the range from “−75” to “−25” (representative value=“−50.0”), a pulse width corresponding to the range from “−25” to “25” (representative value=“0.0”), a pulse width corresponding to the range from “25” to “75” (representative value=“50.0”),” and a pulse width corresponding to the range from 75″ to “100” (representative value=“100.0”) (see FIG. 10, which will be described later).

In this example, among the five numerical ranges mentioned above, the range from “−75” to “−25” (representative value=“−50.0”) is allocated to D2, the range from “−25” to “25” (representative value=“0.0”) is allocated to D3, the range from “25” to “75” (representative value=“50.0”) is allocated to D4, and the range from “75” to “100” (representative value=“100.0”) is allocated to D5. In addition, as described above, the range from “−100” to “−75” (representative value=“−100.0”) is fixed at D1.

For the item of “ON” in the area of “offset,” by setting a numerical value indicating the range of any mode from D2 to D5, a user may instruct a combination of control directions for each gyro sensor 52 during reverse movement to any combination of four preset combinations. Specifically, the mode instructions D2 to D5 may be performed by setting the aforementioned representative values (in other words, any one of “−50.0”, “0.0”, “50.0”, or “100”) to the item of “ON” in the area of “offset”).

The setting area of “speed” is an area for setting the pulse width change speed of a transmission signal when switching ON/OFF of program mixing. As illustrated in the drawings, the setting area of “speed” includes setting items of “IN” and “OUT.” The setting item of “IN” allows designation of the pulse width change speed when program mixing switches from OFF to ON, and the setting item of “OUT” allows designation of the pulse width change speed when program mixing switches from ON to OFF.

Further, in the drawings, the setting area of “delay” is an area for setting the aforementioned delay time length. In this example, the area of “delay” includes setting items of “START” and “STOP.”

The setting item of “START” is an item for setting the delay time when program mixing switches from OFF to ON. Further, the setting item of “stop” is an item for setting a delay time when program mixing switches from ON to OFF.

In setting the delay time length in this example, any time length may be set for the aforementioned setting items of “START” and “STOP.”

The setting screen in FIG. 6 includes a setting area of “switch.” This setting area of “switch” is an area for setting a manipulator for the main manipulation, and in this example, information designating the throttle manipulator may be set.

The setting screen in FIG. 7 includes a setting area of “switching position” for setting the aforementioned ON position and OFF position regarding ON/OFF of program mixing. This setting area of “switching position” has setting items of “ON” and “OFF.” The “ON” is an item for setting the manipulation position as an ON position, and the “OFF” is an item for setting the manipulation position as an OFF position. In this example, since the throttle manipulator is set on the setting screen of FIG. 6, the manipulation position to be set with these “ON” and “OFF” is a throttle manipulation position.

As mentioned above, in this example, in order to provide a dead zone, numerical values other than “0” are set for the setting items of “ON” and “OFF.”

In addition, in the example shown in FIG. 7, the value on an OFF side is a negative value and the value on an ON side is a positive value, but this corresponds to turning on program mixing on a backward movement side. In the setting screen shown in FIG. 7, it is arbitrary whether the numerical values on the OFF side and ON side are expressed as plus or minus, and are not necessarily limited to the illustrated example.

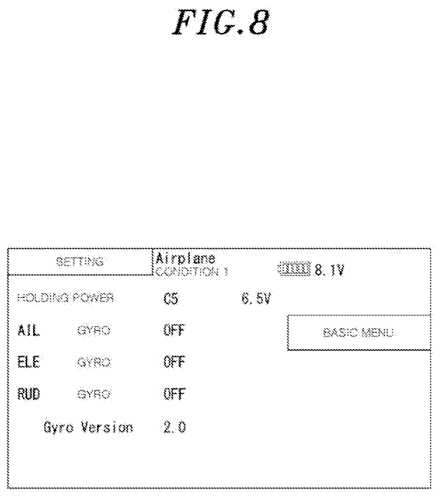

FIGS. 8 to 11 are diagrams for explaining the presetting that need be made to the gyro unit 5 (the gyro controller 51).

In this example, the presetting for the gyro unit 5 may be performed by manipulating the transmitter 3 while the gyro unit 5 is connected to the transmitter 3 by wire. In this example, the setting screens for the gyro unit 5 shown in FIGS. 8 to 11 are displayed on the display screen 33a of the transmitter 3, and a user may perform presetting for the gyro unit 5 by performing touch manipulations on these setting screens.

In addition, it is not essential that the gyro unit 5 be preset via the transmitter 3; for example, the gyro unit 5 may be preset via an information processing device other than the transmitter 3 (for example, personal computers, smartphones, tablet devices, etc.).

FIG. 8 shows an example of a screen displayed in response to connection of the gyro unit 5.

This screen is provided with an item of “Basic Menu.” Although not shown, by selecting this item of “Basic Menu,” various setting menus for the gyro unit 5 are displayed on the display screen 33a, and by selecting any setting menu, a user may call up the corresponding setting screen.

FIG. 9 shows an example of a channel allocation setting screen on the gyro unit 5 side. Similar to FIG. 4 above, a plurality of pages are shown together.

As explained in FIG. 4 above, in this example, CH12 is designated as the channel of “GYRO. REV” in the channel settings on the transmitter 3 side, and thus, correspondingly, on the gyro unit 5 side, CH12 is set to “GYRO.REV.”

FIG. 10 shows an example of a setting screen for modes of D2 to D5 on the gyro unit 5 side.

This setting screen is a screen for linking the pulse width of the received signal of a specific channel and the modes of D2 to D5 on the gyro unit 5 side. As shown in the drawings, on the setting screen, it is possible to designate the pulse width in the range from “−100” to “100” described above for each mode from D2 to D5.

As mentioned above, in this example, it is decided that the range from “−75” to “−25” is allocated to D2, the range from “−25” to “25” is allocated to D3, the range from “25” to “75” is allocated to D4, and the range from “75” to “100” is allocated to D5. Also on the setting screen, pulse widths are designated for each mode so that allocation is made accordingly.

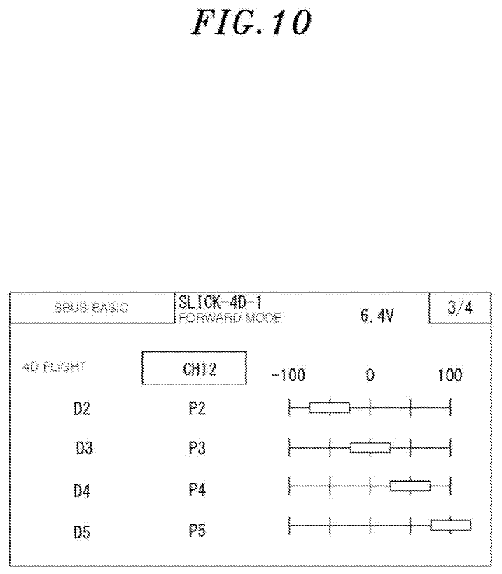

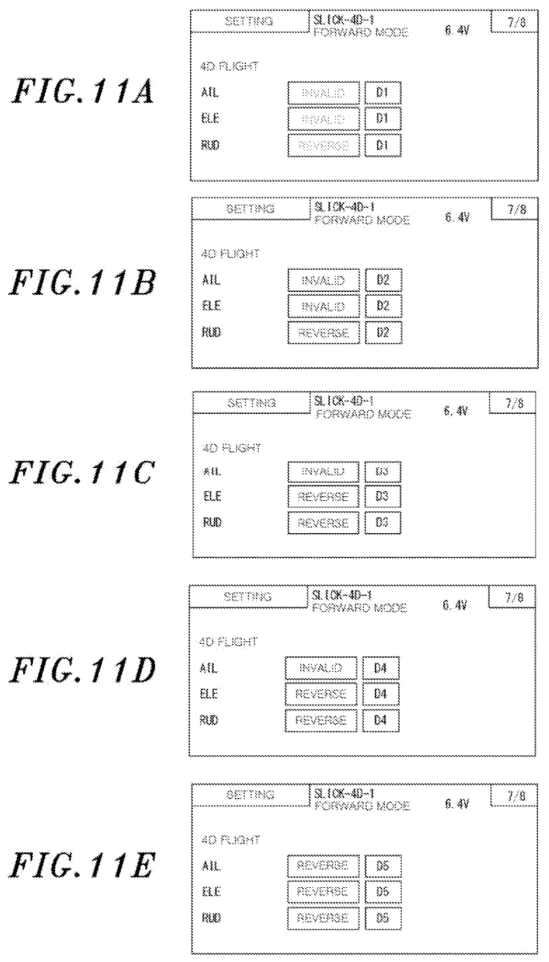

FIGS. 11A to 11E show an example of a setting screen for setting a combination of control directions for each gyro sensor 52 during backward movement.

In this example, on the setting screen of FIGS. 11A to 11E, any of the modes of D1 to D5 may be selected by touching the area where the identifiers of modes of D1 to D5 are displayed. FIG. 11A shows an example of a screen when the mode of D1 is selected. FIG. 11B shows an example of a screen when the mode of D2 is selected. FIG. 11C shows an example of a screen when the mode of D3 is selected. FIG. 11D shows an example of a screen when the mode of D4 is selected. FIG. 11E shows an example of a screen when the mode of D5 is selected.

In the setting screen of FIGS. 11A to 11E, the control direction of posture control may be set for each of the gyro sensors 52 (“AIL”, “ELE”, and “RUD” in the diagram) in the forward direction (“invalid” in the diagram) and in the reverse direction (“reverse” in the diagram).

However, in FIG. 11A, since D1 is in the forward mode, these forward/reverse settings may not be made.

Using the setting screen as illustrated in FIGS. 11A to 11E, a user may preset a combination of control directions for each gyro sensor 52 during backward movement for each mode from D2 to D5.

### 1-5. Example of Processing Procedure

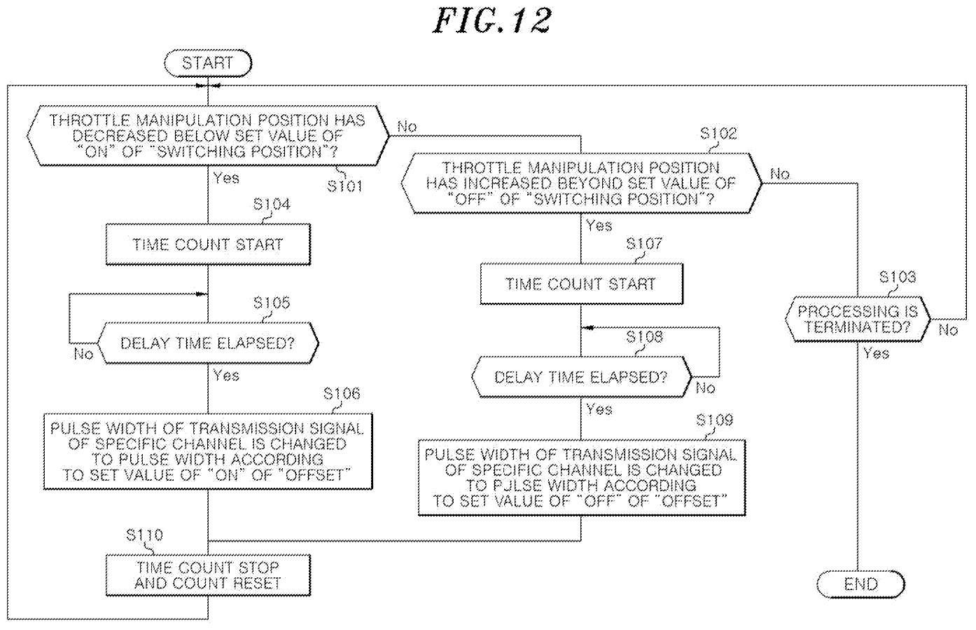

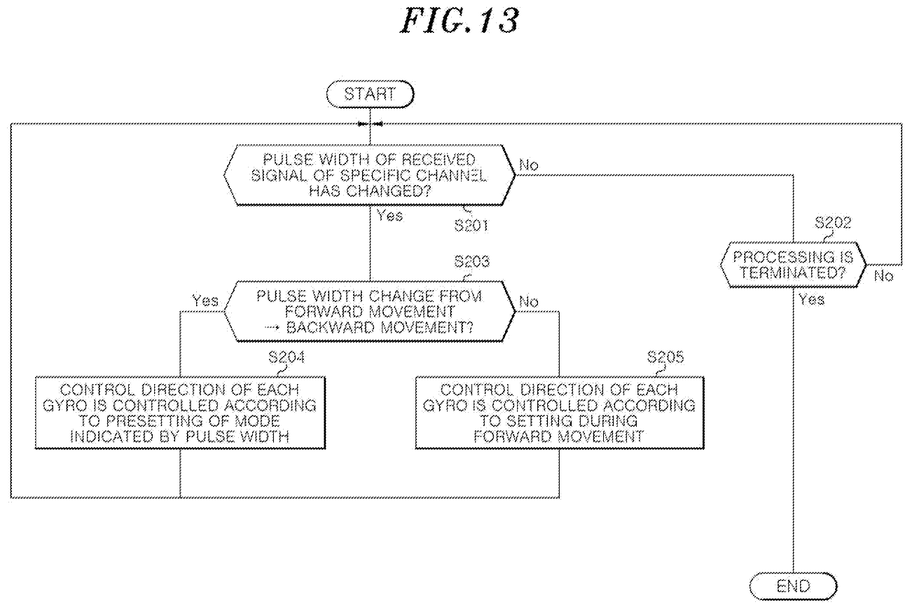

A specific example of processing procedure for implementing the control direction switching method according to the first embodiment will be described with reference to the flowcharts of FIGS. 12 and 13.

FIG. 12 shows an example of a processing procedure on the transmitter 3 side, and FIG. 13 shows an example of a processing procedure on the gyro unit 5 side.

The processing shown in FIG. 12 is executed by the transmitter-side controller 31, and the processing shown in FIG. 13 is executed by the gyro controller 51.

In FIG. 12, the transmitter-side controller 31 first determines in step S101 whether the manipulation position of the throttle has decreased below the set value of “ON” of the “switching position.” In other words, it is determined whether the value of the throttle manipulation position has increased beyond the value of the throttle manipulation position (although it is displayed as a positive value in FIG. 7, it is internally stored as a negative value) set in the item of “ON” of the “switching position” on the setting screen shown in FIG. 7.

When it is determined in step S101 that the throttle manipulation position has not decreased below the set value of “ON” of the “switching position,” the transmitter-side controller 31 proceeds to step S102 and determines whether the throttle manipulation position has increased beyond the set value of “OFF” of the “switching position.” In other words, it is determined whether the value of the throttle manipulation position has increased beyond the value of the throttle manipulation position (although it is displayed as a negative value in FIG. 7, it is internally stored as a positive value) set in the item of “OFF” in the “switching position” on the setting screen shown in FIG. 7.

When it is determined in step S102 that the throttle manipulation position has not increased above the set value of “OFF” of the “switching position,” the transmitter-side controller 31 proceeds to step S103, and determines whether the processing is terminated. In other words, it is determined whether a predetermined condition such as power off, etc., for terminating the processing shown in FIG. 12 is satisfied.

When it is determined in step S103 that the processing has not terminated, the transmitter-side controller 31 returns to step S101.

Through the loop processing of steps S101→S102→S103→S101, the transmitter-side controller 31 waits until any one of the condition that the throttle manipulation position decreases below the set value of “ON” of the “switching position,” the condition that the throttle manipulation position increases above the set value of “OFF” of the “switching position,” or a processing termination condition is satisfied.

In step S101, when it is determined that the throttle manipulation position has decreased below the set value of “ON” of the “switching position,” the transmitter-side controller 31 proceeds to step S104 to start a time count, and waits until the delay time elapses in the following step S105. In other words, the transmitter-side controller 31 waits until the delay time designated by “START” in “delay” on the setting screen of FIG. 5 has elapsed.

When it is determined in step S105 that the delay time has elapsed, the transmitter-side controller 31 proceeds to step S106, and changes the pulse width of the transmission signal of a specific channel to the pulse width according to the set value of “ON” of “offset.” In other words, in this example, the pulse width of the switching notification signal transmitted by CH12 is changed to the pulse width instructed by the set value of “ON” of “offset” on the setting screen of FIG. 5.

As a result, in response to the case where the operation of the steered object 2 is switched from forward movement to backward movement, among the modes of D2 to D5, a control direction switching timing may be instructed to the gyro unit 5 side by the mode instructed by the set value of “ON” of the “offset.”

In response to executing the processing of step S106, the transmitter-side controller 31 advances the processing to step S110, stops the time count started in step S104, performs a processing of resetting the count value, and returns to step S101.

In addition, when it is determined in the previous step S102 that the throttle manipulation position has increased to the value set of “OFF” of the “switching position,” after proceeding to step S107 and starting time counting, the processing waits until the delay time elapses in step S108. The delay time referred to herein is also the delay time designated by “STOP” in “delay” on the setting screen of FIG. 5.

When it is determined in step S108 that the delay time has elapsed, the transmitter-side controller 31 proceeds to step S109, and changes the pulse width of the transmission signal of a specific channel to the pulse width according to the set value of “OFF” of “offset.” In other words, in this example, the pulse width of the switching notification signal transmitted by CH12 is changed to the pulse width instructed by the set value of “OFF” of “offset” on the setting screen of FIG. 5. Specifically, the pulse width is changed to a pulse width corresponding to D1.

As a result, when the operation of the steered object 2 is switched from backward movement to forward movement, an instruction may be given to the gyro unit 5 side to switch the control direction of posture control for each gyro sensor 52 to a direction corresponding to forward movement (forward direction). Also in this case, the timing for switching the control direction may be instructed to the gyro unit 5 side by changing the pulse width of the switching notification signal.

In response to executing the processing of step S109, the transmitter-side controller 31 advances the processing to step S110 described above. In other words, the time count started in step S107 is stopped and the count value is reset.

In response to executing the processing of step S110 as described above, the transmitter-side controller 31 returns to step S101.

Further, when the transmitter-side controller 31 determines in step S103 that the processing has terminated, the transmitter-side controller 31 ends a series of processes shown in FIG. 12.

Next, with reference to FIG. 13, a processing on the gyro unit 5 side will be explained.

In FIG. 13, the gyro controller 51 determines in step S201 whether the pulse width of the received signal of a specific channel has changed. Specifically, in this example, it is determined whether the pulse width of the received signal of CH12 has changed.

When it is determined in step S201 that the pulse width of the received signal of a specific channel has not changed, the gyro controller 51 proceeds to step S202, and determines whether the processing has terminated. In other words, it is determined whether a predetermined condition such as power off, etc., for terminating the processing shown in FIG. 13 is satisfied.

When it is determined in step S202 that the processing has not terminated, the gyro controller 51 returns to step S201.

As a result, the gyro controller 51 waits until either the condition that the pulse width of the received signal of specific channel changes or the processing termination condition is satisfied.

When it is determined in step S201 that the pulse width of the received signal of a specific channel has changed, the gyro controller 51 proceeds to step S203 and determines whether the pulse width has changed in accordance with forward movement→backward movement. Specifically, in this example, it is determined whether the pulse width corresponding to D1 described above has changed to another pulse width.

When it is determined in step S203 that the pulse width changes in accordance with forward movement→backward movement, the gyro controller 51 proceeds to step S204 and controls the control direction of each gyro according to the presetting of a mode indicated by the pulse width. Specifically, based on the pulse width of the received signal of a specific channel, it is determined which mode from D2 to D5 is instructed. For the determined mode, the control direction for each gyro sensor 52 preset on the setting screen of FIGS. 11A to 11E is referred, and the switch 56 of each input switching portion 54 is controlled so that the control direction for each referenced gyro sensor 52 is set.

The gyro controller 51 returns to step S201 in response to executing the processing of step S204.

Furthermore, when the gyro controller 51 determines in step S203 that the pulse width does not change in accordance with forward movement→backward movement, the processing proceeds to step S205 and controls the control direction of each gyro according to the setting for forward movement. In other words, in this example, the switches 56 of each input switching portion 54 are controlled so that the control direction for each gyro sensor 52 is all forward.

The gyro controller 51 returns to step S201 in response to executing the processing of step S205.

Further, when the gyro controller 51 determines in step S202 that the processing is terminated, the gyro controller 51 ends a series of processes shown in FIG. 13.

### 1-6. Another Example of the First Embodiment

Herein, in the above, a combination of control directions for each gyro sensor 52 during backward movement may be selected from among a plurality of combinations by using modes of D2 to D5. However, regarding combinations of control directions for each gyro sensor 52 during backward movement, it is not essential to allow selection from among a plurality of sets in this way.

For example, by using the channel of DG1 prepared by the program mixing function, it is possible to implement a method that does not require selection from a plurality of sets.

In the program mixing function, when the channel of DG1 is designated as the aforementioned “slave” channel (see FIG. 5), switching will occur between two modes, D1 and D5. Accordingly, as for a combination of control directions for each gyro sensor 52 during backward movement, one set as D5 is automatically selected.

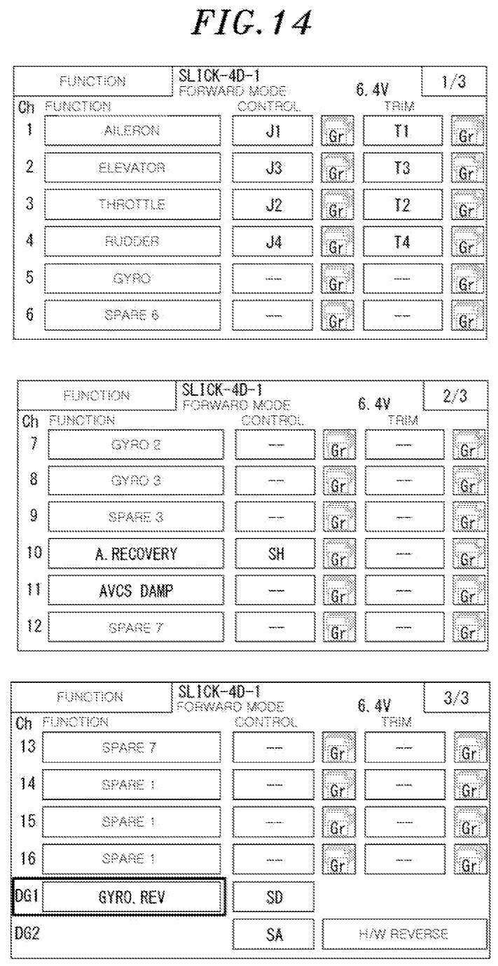

A specific presetting method in this connection will be explained with reference to FIGS. 14 to 17.

FIG. 14 shows an example of a setting screen for setting channel allocation in the transmitter 3, similar to FIG. 4 above. In this connection, the channel of DG1 is set as the channel of “GYRO. REV” as illustrated in the drawings.

Herein, explanation with illustrations will be omitted, but even when the channel of DG1 is designated, on the same setting screen as shown in FIGS. 5 to 7 above, the settings for “slave” and “delay”, the setting for “switch” (main manipulator), and the setting for “switching position” (manipulation position to turn program mixing ON/OFF) are performed. Also in this case, when the aforementioned dead zone is provided, values other than “0” are set for an ON position and an OFF position.

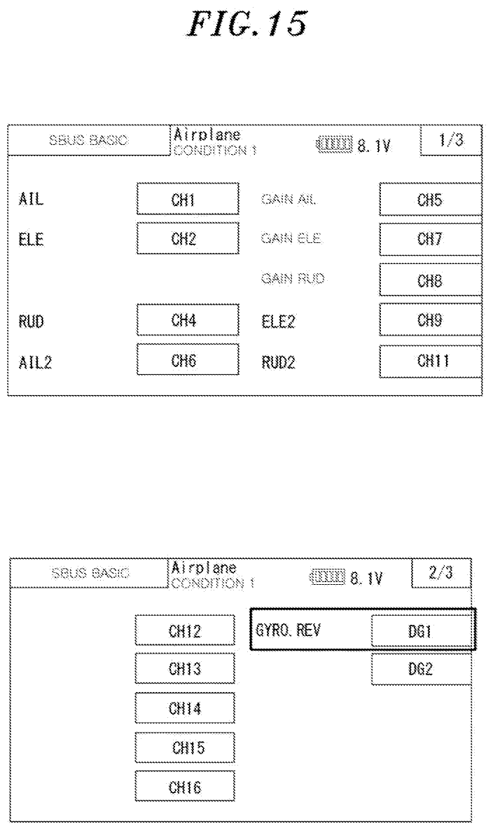

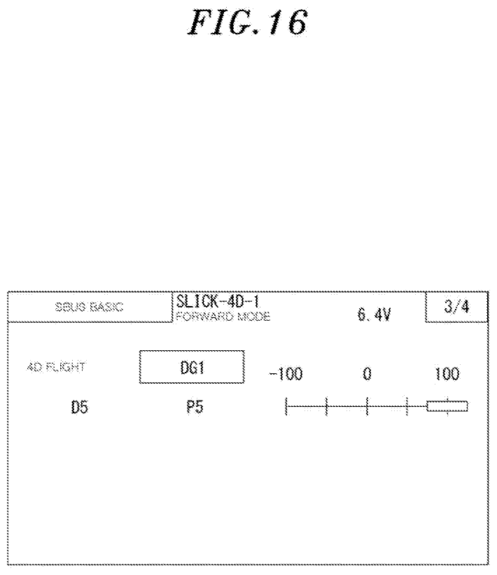

FIGS. 15 to 17 are examples of setting screens on the gyro unit 5 side. As shown in FIG. 15, in this connection, also as a channel allocation setting on the gyro unit 5 side, DG1 is set to “GYRO.REV.”

Further, as shown in FIG. 16, in this connection, since the channel of DG1 is designated, the pulse width of D5 is automatically selected as the pulse width during backward movement (in other words, when program mixing is ON).

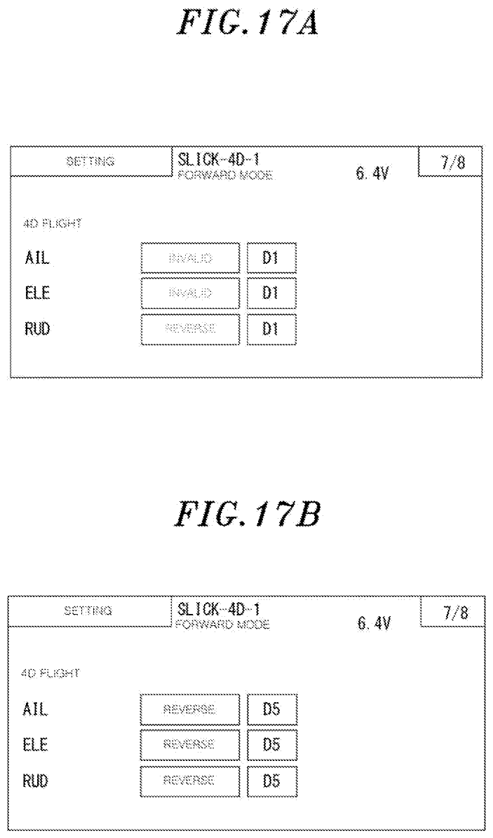

In this connection, a combination of control directions for each gyro sensor 52 is performed only for D5, as shown in FIGS. 17A and 17B.

When the channel of DG1 is used, the transmitter-side controller 31 performs a processing of changing the pulse width of the transmission signal of a specific channel to the pulse width corresponding to D5 in step S106 of the processing shown in FIG. 12 above. Regarding other processing, the same processing as that described with reference to FIG. 12 may be performed.

Further, when the channel of DG1 is used, a gyro controller 51 side may perform the same processing as that described with reference to FIG. 13 above.

### 2. Second Embodiment

Next, a second embodiment will be described.

In the second embodiment, the delay of the control direction switching timing described above is performed on a gyro unit side.

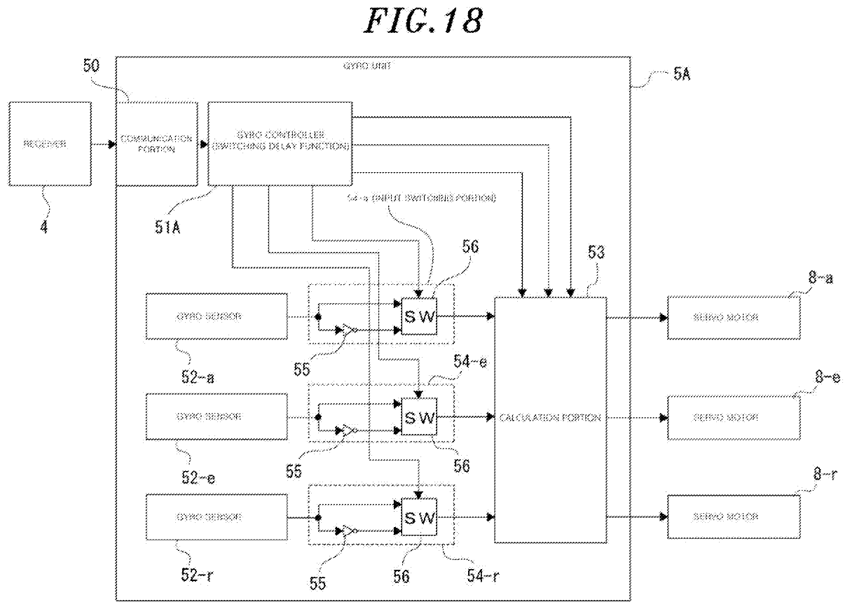

FIG. 18 is an explanatory diagram of a configuration example of a gyro unit 5A as a second embodiment. As in FIG. 3 above, the receiver 4 and servo motors 8-a, 8-e, and 8-r shown in FIG. 2 are shown together.

In the following description, portions that are the same as those already described are assigned with the same reference numerals and the descriptions are omitted.

The gyro unit 5A includes a gyro controller 51A instead of the gyro controller 51, and thus differs from the gyro unit 5. The gyro controller 51A has a delay function regarding control direction switching timing, and thus differs from the gyro controller 51.

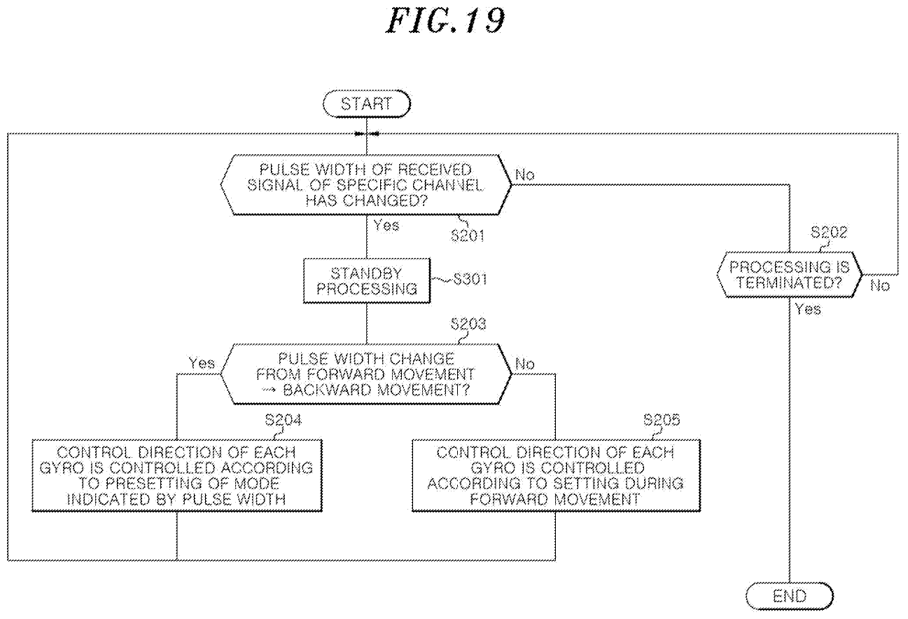

FIG. 19 is a flowchart of processing performed by the gyro controller 51A.

The difference from the processing shown in FIG. 13 above is that when it is determined in step S201 that the pulse width of the received signal of a specific channel has changed, the processing moves to the processing in step S203 after passing through a standby processing in step S301.

By providing the standby processing in step S301, the timing of switching the control direction of posture control is delayed with respect to the timing when the pulse width (signal form) of the switching notification signal changes.

The standby processing in step S301 may be, for example, a processing in which the gyro controller 51 waits for a preset delay time. The delay time in this connection may be variably set based on user manipulation, or a fixed value may be used.

Alternatively, regarding the delay in this connection, it is also possible to provide an estimation portion for estimating the switching between forward movement and backward movement of the steered object 2, and to perform the delay based on the estimation result of the estimation portion.

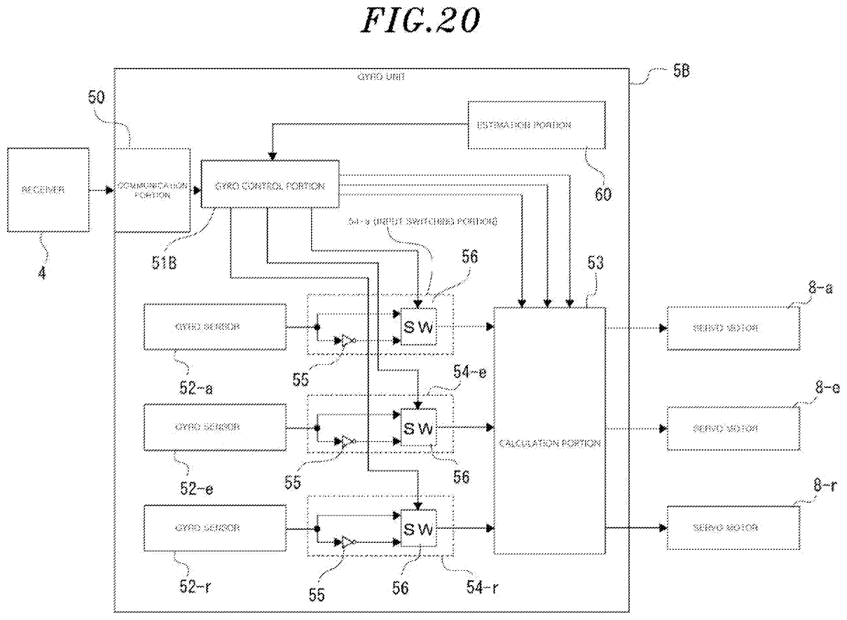

FIG. 20 is an explanatory diagram of a configuration example of a gyro unit 5B as another example of the second embodiment that performs the delay based on the estimation result of the estimation portion in this way.

The gyro unit 5B includes an estimation portion 60 and a gyro controller 51B instead of the gyro controller 51, and thus differs from the gyro unit 5.

The estimation portion 60 estimates whether the steered object 2 is switching between forward movement and backward movement.

A specific example of the estimation portion 60 includes a configuration that estimates switching between forward movement and backward movement of the steered object 2 based on a detection signal from an acceleration sensor (not shown) mounted on the steered object 2.

Specifically, the acceleration sensor in this connection is mounted on the steered object 2 so as to be able to detect the acceleration acting in a forward-backward direction of the steered object 2. The estimation portion 60 estimates whether the steered object 2 switches between forward movement and backward movement based on the acceleration in a forward-backward direction detected by the acceleration sensor.

The acceleration sensor may be provided outside the estimation portion 60 or may be built into the estimation portion 60.

Furthermore, the estimation portion 60 may be configured to estimate whether the steered object 2 switches between forward movement and backward movement based on the detection result of the drive current or drive voltage of the propulsion motor 7.

Specifically, the estimation portion 60 in this connection detects the value of the drive current or drive voltage of the propulsion motor 7. When the value of the drive current or drive voltage remains below a predetermined threshold for a certain period of time or more, the estimation portion 60 estimates that this is a switch between forward movement and backward movement.

When it is determined that the pulse width of the received signal (switching notification signal) of a specific channel has changed, the gyro controller 51B determines whether the estimation portion 60 has estimated a switch between forward movement and backward movement, and in response to the estimation portion 60 estimating the switching between forward movement and backward movement, the switching control of control direction is performed.

Thereby, the timing of switching the control direction may be delayed with respect to the timing of switching between the forward manipulation and the backward manipulation. Specifically, in this connection, the control direction may be switched after it is estimated that the operation of the steered object 2 has actually switched from forward movement to backward movement or from backward movement to forward movement.

In addition, in the case where the delay is performed on the gyro unit side as in the second embodiment, it is optional whether the delay is performed on the transmitter 3 side as in the first embodiment. When the delay is not performed on the transmitter 3 side, the “START” of the “delay” item described above may be set to “0.0 seconds.” Furthermore, when it is desired to have the delay given by the gyro unit as the delay from the polarity change timing of the throttle manipulation position, in setting the “switching position” described above, the set values for both the ON position and the OFF position may be set to “0”.

### 3. Modified Example

It should be noted that the embodiment is not limited to the specific example described above, and various modified configurations may be adopted.

For example, in the second embodiment, an example has been described in which the delay is performed on the gyro unit 5A (or 5B) side, but it is also possible to implement the dead zone related to the control direction switching described above by processing on the gyro unit 5A side.

When a dead zone is implemented through processing on the gyro unit 5A side, a throttle signal is input to the gyro controller 51A.

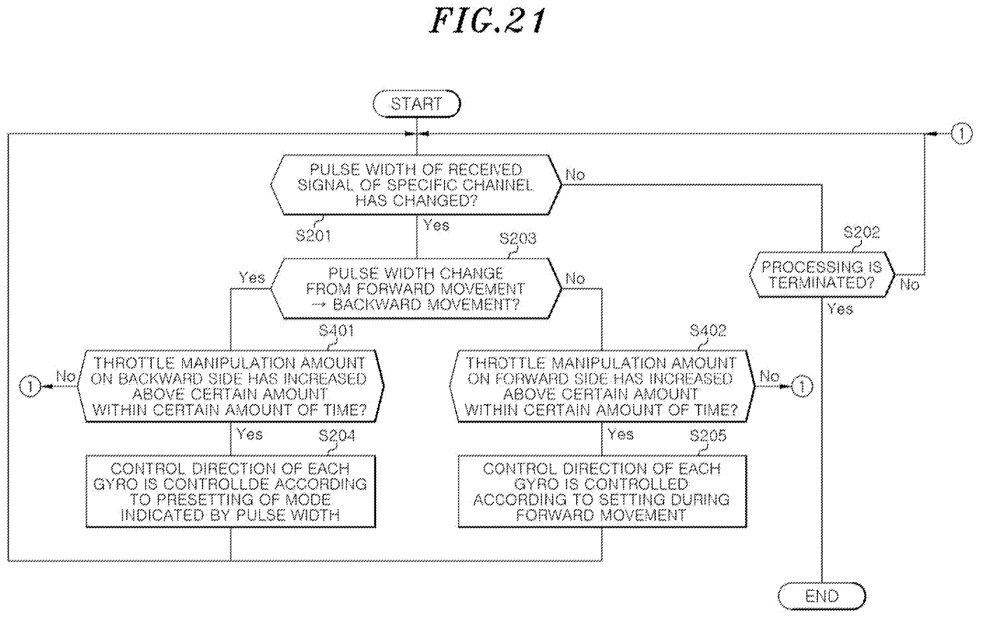

Then, the gyro controller 51A is caused to execute the processing shown in the flowchart of FIG. 21. In addition, in this connection, it is assumed that the transmitter 3 side does not perform delay processing.

As shown in FIG. 21, in this connection, when it is determined in step S203 that the pulse width changes according to forward movement→backward movement, then in step S401, it is determined whether the throttle manipulation amount on a backward side has increased to a predetermined amount or more within a predetermined time. When it is determined in step S401 that the throttle manipulation amount on the backward side has increased to a predetermined amount or more within a predetermined time, the processing moves to step S204. As a result, a dead zone is implemented when switching from forward manipulation to backward manipulation.

As shown in the drawings, when it is determined in step S401 that the throttle manipulation amount on the backward side has not increased to a predetermined amount or more within a predetermined time, the gyro controller 51A returns to step S201.

In addition, in this connection, when it is determined in step S203 that the pulse width does not change according to forward movement→backward movement, then in step S402, it is determined whether the throttle manipulation amount on a forward side has increased to a predetermined amount or more within a predetermined time. When it is determined in step S402 that the throttle manipulation amount on the forward side has increased by a predetermined amount or more within a predetermined time, the processing moves to step S205.

As a result, a dead zone is implemented when switching from backward manipulation to forward manipulation.

When it is determined in step S402 that the throttle manipulation amount on the forward side has not increased by a predetermined amount or more within a predetermined time, the gyro controller 51A returns to step S201.

In addition, the “predetermined amount” in steps S401 and S402 may be variably set based on user manipulation, or a fixed value may be used.

Herein, in the explanation so far, it has been assumed that the steered object 2 is configured to switch between forward movement and backward movement by reversing the rotational direction of the propulsion motor 7, but an embodiment of the present disclosure may also be applied to the steered object 2 that employs a variable pitch propeller.

The variable pitch propeller refers to a screw propeller that may freely change the angle (pitch) of its blades. By changing the pitch, any desired forward and backward propulsion force may be obtained regardless of the rotational direction of the propulsion motor 7.

In this connection, the control direction of the posture control may be switched in accordance with the pitch change of forward/backward switching, rather than the rotational direction of the propulsion motor 7.

In addition, in the explanation so far, an example of using the program mixing function, in other words, an example of using a signal other than the throttle signal as the switching notification signal, has been given. However, it may be contemplated to adopt a method in which a throttle signal is input to the gyro unit 5 (or 5A, 5B), and the gyro controller 51 (or 51A, 51B) determines the forward/backward switching timing based on the throttle signal.

In this connection, it is not necessary to use the program mixing function for switching control of control direction.

Furthermore, in the explanation so far, an example has been given in which the controlled object 2 to which an embodiment of the present disclosure is applied is a model airplane, but an embodiment of the present disclosure is also applicable to the steered object 2 as other flying objects such as a model helicopter or a drone.

Furthermore, an embodiment of the present disclosure may also be applied to the steered object 2 other than flying objects, such as model vehicles and various robots.

### 4. Summary of Embodiments

As explained above, the gyro units 5, 5A, and 5B according to an embodiment are mounted on the steered object 2 that is steered based on a steering signal received from the outside, and include: gyro sensors 52-a, 52-e, 52-r; the calculation portion 53 that performs calculations for posture control of the steered object based on the steering signal and the detection signal of the gyro sensor; and the controller (the gyro controllers 51, 51A, and 51B) that performs control so that the control direction of posture control may be switched between when the steered object moves forward and backward.

By using the gyro unit with the above configuration, the posture control function may be used both during forward movement and backward movement.

Accordingly, it is possible to improve the ease of steering when performing a steering that involves moving the steered object backwards.

In addition, in the gyro unit according to an embodiment, the transmitter 3 that transmits the steering signal has a plurality of channels as signal transmission channels, and transmits a switching notification signal, which is a signal according to forward/backward switching manipulation of the steered object using a predetermined specific channel among the plurality of channels, wherein the controller performs switching control of the control direction based on a transmission signal of the specific channel.

Thereby, it is possible to effectively utilize the existing transmission channel defined by the communication format of the steering system to implement switching control of the posture control direction during forward/backward movement.

Further, the gyro unit according to an embodiment includes the input switching portions 54-a, 54-e, and 54-r configured to enable switching of a non-inversion input state in which a non-inverted signal of the detection signal is input to the calculation portion, and an inversion input state in which an inverted signal of the detection signal is input to the calculation portion, wherein the controller controls the input switching portion as a switching control of the control direction.

As a result, even when PID control is applied to posture control, it is possible to obtain an appropriate posture control signal according to forward/backward switching.

Accordingly, it is possible to improve the accuracy of posture control during forward and backward movement.

Furthermore, the gyro unit according to an embodiment includes a plurality of gyro sensors with different detection target axes of angular velocity as the gyro sensors, and the control direction during backward movement may be individually set for each of the gyro sensors.

For example, depending on the type of performance using the steered object, such as flight performance using the steered object as a flying object, or the preference of a pilot, regarding the control direction during backward movement, it may be requested that the control direction of all gyros (detection target axes) be reversed from the forward direction, or that the control direction of some gyros be the same as the forward direction.

According to the above configuration, it is possible to meet such various needs regarding the control direction of each gyro during backward movement, and it is possible to improve usability.

Furthermore, the gyro unit according to an embodiment is configured such that a combination of control directions for each gyro sensor during backward movement may be selected from among a plurality of preset combinations.

As a result, when a user such as a pilot wants to change the setting of control direction for each gyro during backward movement, the user only has to select any combination from the preset combinations of control directions.

Accordingly, it is possible to reduce the manipulation burden on a user required to change the setting of control direction for each gyro during backward movement.

Furthermore, in the gyro unit according to an embodiment, the transmitter that transmits the steering signal has a plurality of channels as signal transmission channels, and transmits a signal instructing the combination through a predetermined specific channel among the plurality of channels based on user manipulation, wherein the controller selects a combination based on a transmission signal of the specific channel.

According to the above configuration, the controller may select a combination of control directions for each gyro during backward movement based on the instruction signal wirelessly transmitted from the transmitter on a specific channel.

Accordingly, it is not necessary to provide the gyro unit with a manipulator for selecting a combination of control directions for each gyro, or to connect the gyro unit and the transmitter by wire. Furthermore, the setting of the control direction for each gyro during backward movement may be changed even when the steered object as a flying object is in flight, or while the steered object is in operation.

Furthermore, in the gyro unit 5A according to an embodiment, the switching notification signal transmitted by the transmitter is a signal whose signal form changes according to switching between forward manipulation and backward manipulation. The controller 51A delays a timing of switching the control direction with respect to the timing at which the signal form of the switching notification signal changes in response to switching between the forward manipulation and the backward manipulation.

The above delay makes it possible to prevent the control direction from being switched before the operation of the steered object is switched from forward movement to backward movement or from backward movement to forward movement.

Accordingly, it is possible to prevent posture control from being performed in a reverse direction during switching between forward movement and backward movement, and it is possible to improve the stability of posture control.

In addition, the gyro unit 5B according to an embodiment includes the estimation portion 60 for estimating switching between forward movement and backward movement of the steered object, and the controller 51B delays a switching timing of the control direction based on an estimation result of the estimation portion.

This makes it possible to delay the switching timing of the control direction based on the estimation result of whether the operation of the steered object has actually switched from forward movement to backward movement or from backward movement to forward movement.

Accordingly, it is possible to prevent posture control from being performed in a reverse direction during switching between forward movement and backward movement, and it is possible to improve the stability of posture control.

Further, in the gyro unit according to an embodiment, the estimation portion estimates the switching between the forward movement and the backward movement of the steered object based on a detection signal of the acceleration sensor mounted on the steered object.

With the acceleration sensor, the switching between forward movement and backward movement of the steered object may be appropriately estimated.

Furthermore, in the gyro unit according to an embodiment, the estimation portion estimates whether the steered object is switched between the forward movement and the backward movement based on a detection result of a drive current or drive voltage of the propulsion motor of the steered object.

During switching between forward movement and backward movement, the value of the drive current or drive voltage of the propulsion motor once goes through “0.”

Accordingly, based on the detection results of the drive current or drive voltage of the propulsion motor, the switching between forward movement and backward movement of the steered object may be appropriately estimated.

Furthermore, in the gyro unit according to an embodiment, when a switching manipulation between the forward movement and the backward movement of the steered object is performed, the controller does not control the switching of the control direction until the manipulation amount of thrust in the direction of progress after the switching exceeds a predetermined manipulation amount (see FIG. 21, etc.).

This makes it possible to prevent the control direction from being switched before the operation of the steered object is switched from forward movement to backward movement or from backward movement to forward movement.

Accordingly, it is possible to prevent posture control from being performed in a reverse direction during switching between forward movement and backward movement, and it is possible to improve the stability of posture control.

The steering system according to an embodiment includes: the transmitter 3 that transmits a steering signal to the steered object 2 that is steered based on the steering signal; and the gyro unit 5, 5A, and 5B mounted on the steered object, wherein the transmitter includes the transmission portion 34 for transmitting signals, and the gyro unit includes: the gyro sensor 52-a, 52-e, and 52-r; the calculation portion 53 that performs calculations for posture control of the steered object based on a detection signal of the gyro sensor; and a gyro-side controller (the gyro controllers 51, 51A, and 51B) that performs control so that a control direction of the posture control is switched between when the steered object moves forward and backward.

By using the gyro unit with the above configuration, the posture control function may be used both during forward movement and backward movement.

Accordingly, it is possible to improve the ease of steering when performing steering that involves the backward movement of the steered object.

Further, in the steering system according to an embodiment, the transmitter includes the transmitter-side controller 31 that causes the transmission portion to transmit a signal instructing switching of the control direction at a timing delayed with respect to the switching manipulation timing between forward movement and backward movement for the steered object.

The above delay makes it possible to prevent the control direction from being switched before the operation of the steered object is switched from forward movement to backward movement or from backward movement to forward movement.

Accordingly, it is possible to prevent posture control from being performed in a reverse direction during switching between forward movement and backward movement, and it is possible to improve the stability of posture control.

Furthermore, in the steering system according to an embodiment, the transmitter includes a transmitter-side controller 31 that instructs the gyro unit to switch the control direction based on a switching manipulation of forward movement and backward movement of the steered object. The transmitter-side controller does not give an instruction to switch the control direction with respect to the switching manipulation between the forward movement and the backward movement until the manipulation amount of thrust in the direction of progress after 5 switching exceeds a predetermined manipulation amount.

This makes it possible to prevent the control direction from being switched before the operation of the steered object is switched from forward movement to backward movement or from backward movement to forward movement.

Accordingly, it is possible to prevent posture control from being performed in a reverse direction during switching between forward movement and backward movement, and it is possible to improve the stability of posture control.

1. A gyro unit mounted on a steered object for performing steering based on a steering signal received from the outside, the gyro unit comprising:
a gyro sensor;
a calculation portion configured to perform calculations for posture control of the steered object based on the steering signal and a detection signal of the gyro sensor; and
a controller configured to perform control such that a control direction of the posture control switches when the steered object moves forward and backward.

2. The gyro unit of claim 1, wherein:
a transmitter configured to transmit the steering signal has a plurality of channels as signal transmission channels, and transmit a switching notification signal based on forward/backward switching manipulation of the steered object using a predetermined specific channel among the plurality of channels; and
the controller is configured to perform switching control of the control direction based on the switching notification signal of the specific channel.

3. The gyro unit of claim 1, further comprising an input switching portion configured to enable switching of a non-inversion input state in which a non-inverted signal of the detection signal is input to the calculation portion, and an inversion input state in which an inverted signal of the detection signal is input to the calculation portion,
wherein the controller is configured to control the input switching portion as a switching control of the control direction.

4. The gyro unit of claim 1, further comprising a plurality of gyro sensors with different axes for detecting angular velocity, wherein the control direction during backward movement is individually set for each of the gyro sensors.

5. The gyro unit of claim 4, wherein a combination of the control directions for each of the gyro sensors during backward movement is selected from among a plurality of preset combinations.

6. The gyro unit of claim 5, wherein:
a transmitter configured to transmit the steering signal has a plurality of channels as signal transmission channels, and transmit a signal instructing the combination through a predetermined specific channel among the plurality of channels based on user manipulation; and
the controller is configured to select the combination based on a transmission signal of the specific channel.

7. The gyro unit of claim 2, wherein:
the switching notification signal transmitted by the transmitter is a signal whose signal form changes based on switching between forward manipulation and backward manipulation; and
the controller is configured to delay a switching timing of the control direction with respect to a timing at which the signal form of the switching notification signal changes based on switching between the forward manipulation and the backward manipulation.

8. The gyro unit of claim 7, further comprising an estimation portion configured to estimate switching between forward movement and backward movement of the steered object,
wherein the controller is configured to delay the switching timing of the control direction based on an estimation result of the estimation portion.

9. The gyro unit of claim 8, wherein the estimation portion is configured to estimate the switching between the forward movement and the backward movement of the steered object based on a detection signal of an acceleration sensor mounted on the steered object.

10. The gyro unit of claim 8, wherein the estimation portion is configured to estimate whether the steered object switches between the forward movement and the backward movement based on a detection result of a drive current or drive voltage of a propulsion motor of the steered object.

11. The gyro unit of claim 1, wherein, when a switching manipulation between the forward movement and the backward movement of the steered object is performed, the controller does not perform switching control of the control direction until a manipulation amount of thrust in the direction of progress after the switching exceeds a predetermined manipulation amount.

12. A steering system comprising: a transmitter configured to transmit a steering signal to a steered object to be steered based on the steering signal; and
a gyro unit mounted on the steered object, wherein:
the transmitter comprises a transmission portion for transmitting signals; and
the gyro unit comprises:
a gyro sensor;
a calculation portion configured to perform calculations for posture control of the steered object based on a detection signal of the gyro sensor; and
a gyro-side controller configured to perform control such that a control direction of the posture control switches when the steered object moves forward and backward.

13. The steering system of claim 12, wherein the transmitter comprises a transmitter-side controller that causes the transmission portion to transmit a signal instructing switching of the control direction at a timing delayed with respect to a switching manipulation timing between forward movement and backward movement for the steered object.

14. The steering system of claim 12, wherein:
the transmitter comprises a transmitter-side controller that instructs the gyro unit to switch the control direction based on a switching manipulation of forward movement and backward movement of the steered object; and
the transmitter-side controller does not give an instruction to switch the control direction with respect to the switching manipulation between the forward movement and the backward movement until a manipulation amount of thrust in the direction of progress after switching exceeds a predetermined manipulation amount.
